(19) United States
(12) Patent Application Publication
(10) Pub. No.: US 2026/0288220 A1
(43) Pub. Date: Sep. 24, 2026

(54) CIRCUITRY AND METHODS FOR MITIGATING PROCESSING EVENTS

(71) Applicant: Arm Limited, Cambridge (GB)

(72) Inventors: Sumant SRIKANT, Cambridge (GB); Yimajian YAN, Santa Clara, CA (US); Fredrik Peter STOLT, Lund (SE); Javier DELACRUZ, San Jose, CA (US); Rainer HERBERHOLZ, Great Abington (GB)

(21) Appl. No.: 19/088,105

(22) Filed: Mar. 24, 2025

(51) Int. Cl. G06F 1/3203

(52) U.S. Cl. CPC G06F 1/3203

(57) ABSTRACT

Systems, devices, and methods for controlling processing transitions at compute units, including receiving a request to transition from a first performance state to a second performance state in accordance with a first transition setting and determining the number of compute units permitted to transition from the first performance state to the second performance state in accordance with the first transition setting, and providing permission for the first compute unit to transition in accordance with the first transition setting responsive to a determination that the first compute unit would not exceed a threshold number of compute units permitted to transition.

### TECHNICAL FIELD

The present techniques relate to mitigating performance issues during processing. In particular, the present techniques relate to circuitry and related methods therefor.

### BACKGROUND

Performance issues may arise in a data processing system having multiple compute units in a shared power delivery network (PDN) when the PDN cannot adapt to rapidly changing power demands of the compute units.

Passive techniques can be implemented in a data processing system to mitigate such performance issues, such as improving system design to decrease the resistance or inductance or adding decoupling capacitors to increase the amount of stored charge. However, there is generally a finite space amount of available design space so there is only a limited amount of design improvements that can be made to the system or decoupling capacitors that can be added to the system. Also, the cost of such improvements of the PDN may be prohibitive.

Additionally, active techniques such as adaptive clocking to mitigate voltage droop can be implemented, but such techniques generally address the consequences of the voltage droop rather than preventing the power integrity issues.

There is a need for additional or alternative techniques to address such issues.

### SUMMARY

The present techniques relate to addressing or mitigating such performance issues or improving known mitigation techniques.

According to a first aspect, there is provided a control unit for controlling processing transitions at a plurality of compute units, the control unit comprising: a request analysis component to receive, from a first compute unit, a request to transition from a first performance state to a second performance state in accordance with a first transition setting and to determine the number of compute units permitted to transition from the first performance state to the second performance state in accordance with the first transition setting, where the first transition setting is to define a transition rate for the transition; a control unit configured to provide, to the first compute unit, permission for the first compute unit to transition in accordance with the first transition setting responsive to a determination that the first compute unit would not exceed a threshold number of compute units permitted to transition in accordance with the first transition setting.

According to a further aspect, there is provided a system to perform processing comprising: the control unit of the first aspect above; and a compute unit comprising: an interface component to communicate with the control unit; a functional unit capable of transitioning from a first performance state to a second performance state in accordance with a first transition setting or a second transition setting, where the first transition setting is to define a first transition rate for the transition and where the second transition setting is to define a second transition rate for the transition; where the interface component is configured to request, from the control unit, permission to transition in accordance with the first transition setting.

According to a further aspect there is provided a method of controlling processing transitions at a plurality of compute units, the method comprising: receiving, at a control unit from a compute unit, a request for the compute unit to transition from a first performance state to a second performance state in accordance with a first transition setting, where the first transition setting is to define a first transition rate for the transition; determining, at the control unit, the number of compute units permitted to transition from the first performance state to the second performance state in accordance with the first transition setting; providing, to the compute unit, permission to transition in accordance with the first transition setting responsive to a determination that providing the permission would not exceed a threshold number of compute units permitted to transition in accordance with the first transition setting.

According to a further aspect, there is provided a system comprising: the above control unit comprising circuitry, implemented in at least one packaged chip; at least one system component; and a board, wherein the at least one packaged chip and the at least one system component are assembled on the board.

According to a further aspect, there is provided a chip-containing product comprising the above system assembled on a further board with at least one other product component.

According to a further aspect, there is provided a non-transitory computer-readable medium to store computer-readable code for fabrication of the above circuitry.

### BRIEF DESCRIPTION OF THE DRAWINGS

Embodiments of the present techniques will now be described by way of example only and with reference to the accompanying drawings, in which:

FIG. 1 schematically shows a block diagram of a system comprising a control unit for controlling transitions in power dissipation at a plurality of compute units in accordance with the present techniques;

FIG. 2 schematically shows a block diagram of the control unit of the system of FIG. 1 in accordance with the present techniques;

FIG. 3 schematically shows a block diagram of the system of FIG. 1 in greater detail;

FIG. 4 schematically shows a block diagram of system comprising a control unit for controlling transitions in power dissipation at a plurality of compute units in accordance with a further embodiment of the present techniques;

FIG. 5 schematically shows an example of a compute unit in accordance with the present techniques;

FIG. 6 schematically shows a simplified flow diagram of a method of operation of the control unit of FIG. 2 in accordance with the present techniques;

FIG. 7 schematically shows a simplified flow diagram of a method of operation of a compute unit in accordance with the present techniques; and

FIG. 8 illustrates a system and a chip-containing product in accordance with the present techniques.

### DETAILED DESCRIPTION

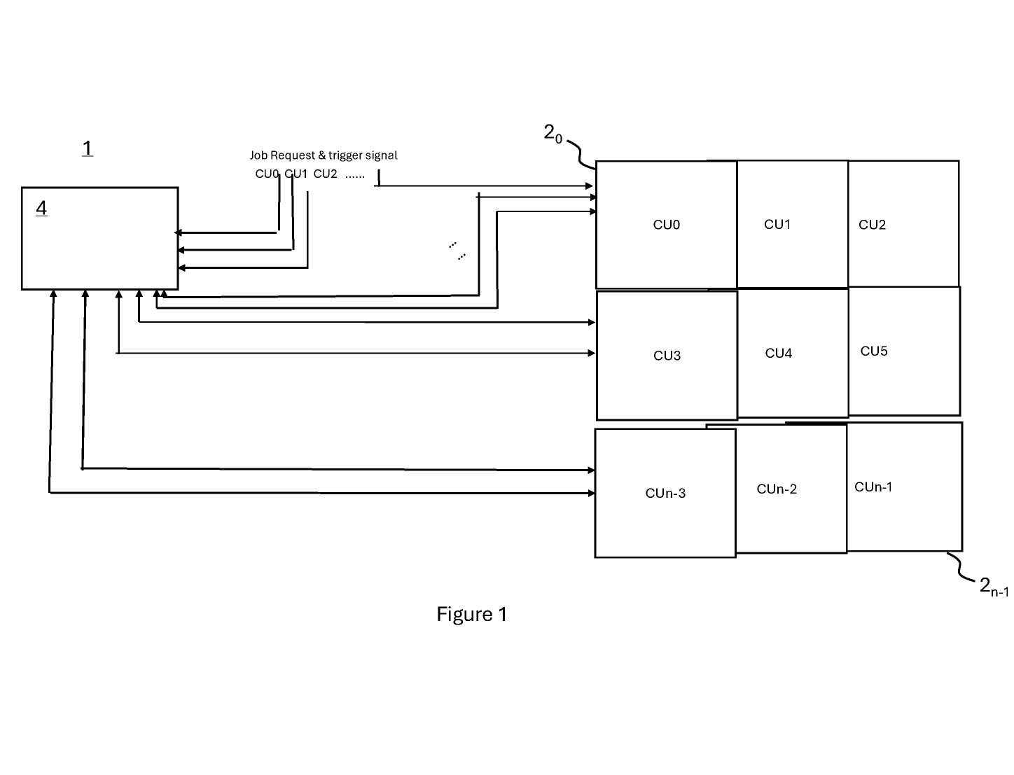

FIG. 1 schematically shows a block diagram of a data multi-processor system 1, for example a System-on-Chip (SoC), comprising a plurality of compute units 2ₙwhich are to process job requests. Such compute units may comprise one or more instances of a neural processor unit (NPU), a central processing unit (CPU) and/or graphics processor unit (GPU) or other such processor unit. In other embodiments the compute units may comprise one or more functional units of a CPU (e.g. a CPU core), GPU (e.g. a GPU core), NPU (e.g. a neural engine (NE)) etc.

The system 1 may also comprise a resource management processor (not shown) for managing the system resources (not shown in FIG. 1). Such a resource management processor may comprise a micro-controller, and where the system resources may means to control temperature e.g. temperature sensors, control of fans, power resource(s) (e.g. voltage regulators) and clock resource(s) (e.g. phase locked loop (PLL) sources) where a software component such as firmware running at that resource management processor may monitor various signals (e.g. telemetry signals) in the system and control resource allocation to each of the compute units 2ₙ accordingly. For example the firmware may receive telemetry signals from various units/sensors and then control power budgets responsive to the telemetry signals. For example, the firmware may, responsive to telemetry signals, control voltage regulators to supply a particular voltage to the various compute units or may control frequency points of phase locked loop (PLL) sources to provide clock signals to the various compute units.

In the illustrative example, the compute units are within the same power distribution network (PDN) (e.g. tied to the same voltage supply rail (i.e. same voltage domain)), where a voltage regulator supplies power to the compute units, to enable the compute units to process the job requests. The voltage regulator attempts to control the voltage at the compute units within the capabilities of the voltage regulator bandwidth and the impedance of the PDN.

When beginning to process a job, the compute units may transition (i.e. a processing transition) from a relatively low power or low performance state (e.g. at startup or from idle (waiting for a job or data)) to a relatively high power or high performance state, where the higher performance may be achieved by a compute unit operating at, for example, a higher frequency, or using a greater number of functional units/execution units although the claims are not limited in this respect.

As will be appreciated, a compute unit operating in a high performance state will consume more power (e.g. draw more current) than when operating in a relatively low performance state and a faster rate of transition from the low performance state to the high performance state will result in a steeper load step (current ramp or transient) compared to a relatively slower rate of transition from the low performance state to the high performance state.

When multiple compute units concurrently or substantially simultaneously transition to the higher performance state, then when the magnitude and transition rate of the load step for the multiple compute units exceeds the capabilities of the PDN to supply sufficient current, (e.g. due to resistance and inductance in the system and a finite amount of charge available to be obtained from the capacitance stored in the system), then a voltage droop may cause the supply voltage at the functional units to fall below a minimum operating voltage, thereby leading to issues such as timing failures within digital logic or errors accessing internal memories.

As an illustrative example, for a PDN having a dominant resonance of 100MHz, then the response time of that PDN will be ~10ns. Thus, power integrity issues may occur when, within a time window (e.g. 10ns), the transition rate of a plurality of compute units concurrently transitioning from the low performance state to the high performance state may exceed the capabilities of the PDN to supply sufficient current to meet the load step demands of the transitions.

Although passive and active techniques described above can be used to mitigate performance issues, the present techniques provide additional or alternative mitigation techniques.

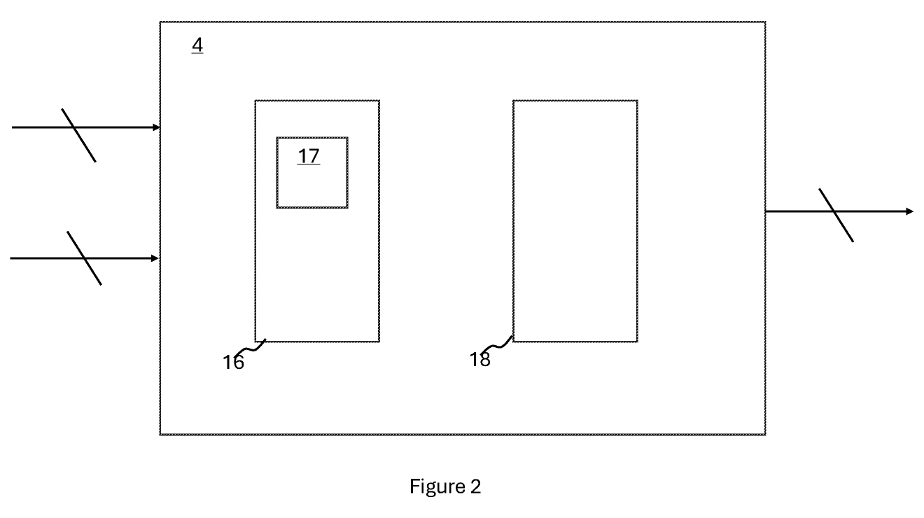

Looking again at FIGS. 1 and 2, a hardware (HW) control unit 4 is arranged to receive a request signal (e.g. a HW signal) from each of the respective compute units 2ₙ, where a request signal is an indication that the compute unit requires a fast transition (or ramp) from the low performance state to the high performance state to process a job request. The resource management processor may signal to a particular compute unit that it must transition from a low performance state to a high performance state and may also programme the properties of the transition (e.g. a desired transition rate).

The control unit 4 is also arranged to communicate with the resource management processor, where the management processor may set (e.g. using one or more register settings) properties of the control unit 4 responsive to, for example, the state of the system resources or capability of the PDN.

The control unit 4 comprises a request analysis component 16 and compute unit control component 18 to control a plurality of compute units in which it is arranged in communication.

As above, each compute unit is configured to process job requests (e.g. fetch data, split tasks, execute instructions etc.). In addition, and in accordance with the present techniques, when the job execution causes a compute unit to transition from a low performance state to a high performance state, the compute unit communicates with the control unit 4 to request permission to increase its load current (e.g. power consumption) in accordance with a first transition setting, where the first transition setting comprises a configuration setting that defines a rate of transition from a relatively low performance state to a relatively high performance state for the compute unit. In a preferred embodiment, a transition duration from the low performance state to the high performance state for a compute unit transitioning to the high performance state in accordance with the first transition setting is shorter than the inverse of the frequency of dominant resonances in the impedance spectrum of the PDN. The properties of the PDN may be determined by simulation during the design stage or during characterization of the system.

In embodiments, a transition duration from the low performance state to the high performance state for a compute unit transitioning to the high performance state in accordance with a second transition setting is longer than the transition duration from the low performance state to the high performance state for the compute unit transitioning to the high performance state in accordance with the first transition setting. In embodiments the second transition setting may be a default transition setting for each of the compute units, where when transitioning to the high performance state in accordance with the default transition setting, the transition to the higher performance state will be slower than when transitioning to the high performance state in accordance with the first transition setting.

On receiving a request from a particular compute unit, the control logic, using request analysis circuitry 16, determines whether the request from that particular compute unit exceeds a threshold of requests.

When it’s determined that the request from the particular compute unit does not exceed the threshold of requests, then the control unit provides permission to that particular compute unit to increase the load current in accordance with the first transition setting (i.e. with a relatively slower processing transition).

When it’s determined that the request from the particular compute unit does exceed the threshold of requests, then the control unit withholds (or denies) permission from that particular compute unit to process the job in accordance with the first transition setting, and the particular compute unit processes the job in accordance with the second transition setting (i.e. with a relatively slow processing transition).

In embodiments, the request analysis circuitry 16 may comprise a counter 17 which is incremented when permission is granted to a compute unit and decremented when, for example, a compute unit granted permission to transition in accordance with the first transition setting informs the control unit that the transition to the high performance state is complete. In this way the control unit 4 can track the number of individual compute units permitted to transition to the high performance state in accordance with the first transition setting at a particular time.

Therefore, the first transition setting comprises a configuration setting where the compute unit is permitted to transition the high performance state over a relatively short time period (e.g. substantially instantaneously w.r.t. to the response time of the PDN), whereas the second transition setting comprises a configuration setting where the compute unit transitions from the relatively low performance state to the relatively high performance state over a longer time period (i.e. slower transition rate) compared to when transitioning in accordance with the first transition setting.

As previously described, a compute unit transitioning to the high performance state will draw current with a steeper load step (e.g. current ramp or transient) compared to a relatively slow transition to the high performance state, and while the system may tolerate a steep current ramp by a certain number of compute units concurrently transitioning from the low performance state to the high performance relatively quickly (i.e. in accordance with the first transition setting), increasing the number of compute units of activating their arrays concurrently beyond that threshold number will result in adverse effects (E.g. voltage droop). Thus, the number of compute units that are permitted to transition to the high performance state in accordance with the first transition setting is controlled within a threshold number, and when the threshold number of compute units is reached, any compute unit requesting to transition to the high performance state in accordance with the first transition setting is denied permission to do so and will transition to the high performance state in accordance with the second transition setting (i.e. transitioning from the low performance state to the high performance relatively slowly).

By controlling the number of compute units that transition from the low performance state to a high performance state in accordance with the first or second transition settings means that the current drawn by the compute units can be controlled such that the current will be ramped up within the capabilities of the PDN. Controlling the plurality of compute units in this manner can reduce the likelihood of any performance issues that may otherwise occur when all compute units transition substantially simultaneously in a manner that is not within the capabilities of the PDN.

Thus, in accordance with the present techniques, the control unit provides permission to a threshold number of compute devices to transition to the high performance state in accordance with the first transition setting, where a compute device may request permission when it’s determined that it is required to transition to the high performance state in accordance with the first transition setting (e.g. responsive to signals from the resource management processor).

The threshold number of compute devices may be programmable based on system requirements, for example based on signals from the resource management processor. In embodiments, the resource management processor may monitor system resources (e.g. via telemetry values) to determine the capabilities of the PDN and set the threshold accordingly.

When it’s determined that a request from a particular compute unit does not exceed the threshold, then the control unit may provide permission to that particular compute unit to perform a processing transition in accordance with the first transition setting (thereby permitting a relatively quick transition from the low performance state to the high performance state).

Permission may be provided to the particular compute unit by way, for example, of a token or by setting a value of a register at the particular compute unit or by setting a flag at the particular compute unit. The claims are not limited in this respect, and permission may be granted in any suitable manner.

In an illustrative example, when it’s determined that the request from the particular compute unit does not exceed the threshold of requests, the control unit may provide a token to that particular compute unit, where the token may be stored in a configuration register. When the token is stored in the configuration register the particular compute unit may transition to the high performance state in accordance with the first transition setting (i.e. faster transition to the high performance state), and when no token is stored, then the particular compute unit may transition to the high performance state in accordance with the second transition setting (i.e. having a slower transition to the high performance state).

In a further illustrative example, when it’s determined that the request from the particular compute unit does not exceed the threshold number of requests, the control unit may set a flag or set a particular value in a configuration register (or other storage) at the particular compute unit, where when the flag is set or value stored then the particular compute unit may transition to the high performance state in accordance with the first transition setting (i.e. faster transition to the high performance state), and when no flag is set or value stored, then the particular compute unit may transition to the high performance state in accordance with the second transition setting (i.e. slower transition to the high performance state).

In this way, the control unit can control the processing transitions of individual compute units to mitigate any adverse effects that may otherwise result from too many compute units transitioning to the high performance state in accordance with the first transition setting. Such an adverse effect may be a droop event for example.

In embodiments, the permission may be set to expire after a specified period of time (i.e. validity duration) has elapsed such that, and using the example of a token, a compute unit provided with a token that has a validity duration may transition to the high performance state in accordance with the first transition setting so long as the validity duration has not elapsed (i.e. so long as the permission has not expired), and the particular compute unit may transition to the high performance state in accordance with the second transition setting after the validity duration elapses (e.g. when the permission expires).

Such functionality means that a compute unit may receive an indication that it is required to perform a processing transition in accordance with the first transition setting, where the compute unit requests permission from the control unit to transition to the high performance state in accordance with the first transition setting. While the compute unit may receive permission (e.g. a token that has a validity duration) the compute unit may not receive the data required to begin processing the job until after the permission expires (e.g. due to waiting for data from another process). In that case, the compute unit may request an updated token when the data is received or transition to the high performance state in accordance with the second transition setting to process the data. A token may also expire without a power transition taking place, where a telemetry indication used to request the token is predictive in nature and an unexpected branch in the job execution occurs. Thus, in embodiments, once permission defining a validity duration is received, the compute unit has a defined period in which to perform a fast transition.

Furthermore, the control unit may receive requests from multiple compute units substantially simultaneously (e.g. within the same clock cycle), where granting two or more of the requests would exceed the threshold number of compute units. In such a scenario, the control unit may determine which compute unit(s) should be granted permission and which should be denied permission using any suitable arbitration scheme. For example, compute units having a high priority (e.g. determined by an ID value provided in the request) may be granted permission before compute units having a lower priority. In a further example, the control unit may arbitrarily decide which compute unit(s) should be granted permission (e.g. where the compute unit having the lowest ID value may be granted permission first).

In embodiments, the counter 17 may be decremented when a validity duration for which permission was granted elapses. As an illustrative example, a token having a specified validity duration (e.g. ns, µs etc.) may be provided to the compute unit, where a timer at the control unit is initiated when the token is provided to the compute unit and when the timer reaches a specified value (corresponding to the validity duration (e.g. when the timer reaches zero)), the counter will be decremented as the token provided to that compute unit will no longer be valid and the compute unit will transition to the high performance state at the slower transition rate in accordance with the second transition setting.

Thus, the control unit 4 can update the counter when permissions provided to the compute units are taken to expire, thereby providing real-time tracking of permissions.

As above, power integrity issues may occur when, within a particular time window, the transition rate of a plurality of compute units concurrently transitioning from the low performance state to the high performance state may exceed the capabilities of the PDN to supply sufficient current to meet the load step demands of the transitions. Thus, in embodiments, the control unit may determine the number of compute units permitted to transition from the first performance state to the second performance state in accordance with the first transition setting within a particular time window (e.g. 10ns), where the time window may be programmable. Thus, the number of compute units permitted to transition from the first performance state to the second performance state in accordance with the first transition setting in the time window can be controlled to be within the capabilities of the PDN,

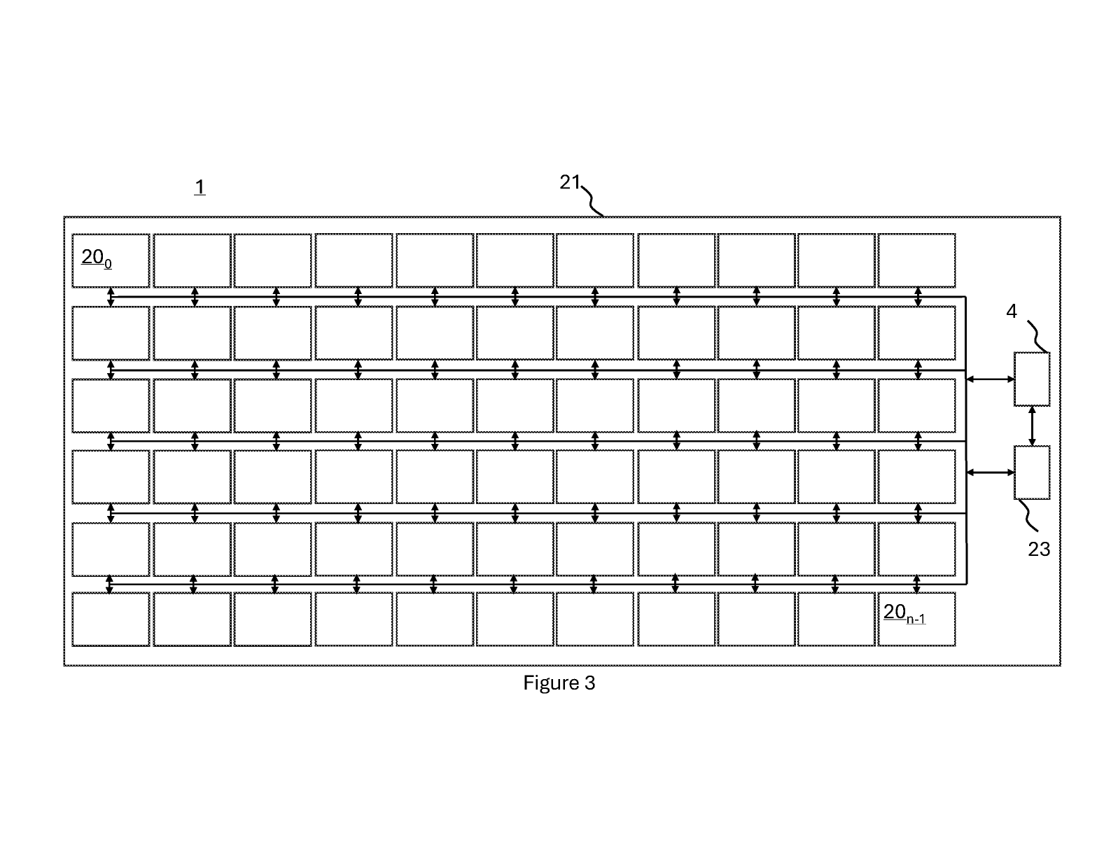

FIG. 3 schematically shows a block diagram of the system 1 in greater detail, where a plurality of tile units 20ₙ are arranged as an array on a compute die 21. Each tile unit may comprise a plurality of compute units such as a compute unit and a CPU or GPU.

A control unit 4 is also provided on the compute die 20 in communication with each of the tile units.

A resource management processor 23 is also provided in communication with the tile units 20ₙ. As above, such a resource management processor 23 may comprise a micro-controller, where a software component such as firmware running at that control processor may control the system resources of each of the compute units 2ₙ. The resource management processor 23 may define, at the control unit (e.g. in a register) the threshold number of compute units that can be provided with permissions.

The resource management processor 23 may also set the transition properties (e.g. the ramp rates) at the respective compute units.

While only one control unit 4 is depicted in FIG. 3, the claims are not limited in this respect and, in embodiments, the compute units may be grouped, such that a first group of compute units is provided in communication with a first control unit, a second group of compute units is provided in communication with a second control unit and so on.

Furthermore, the control unit may be standalone circuitry on the compute die. Alternatively, the control unit may be remote from the compute die on which the compute units are located.

As will be appreciated, other components or circuitry such as power management components (e.g. voltage regulators, voltage supply lines etc.) or clock control circuits may be provided on the compute die 20 dependent on the required functionality of the system 1.

As will be appreciated, the claims are not limited to controlling the transition settings of any particular type of compute unit, and such a compute unit may be a CPU, NE, and/or GPU etc.

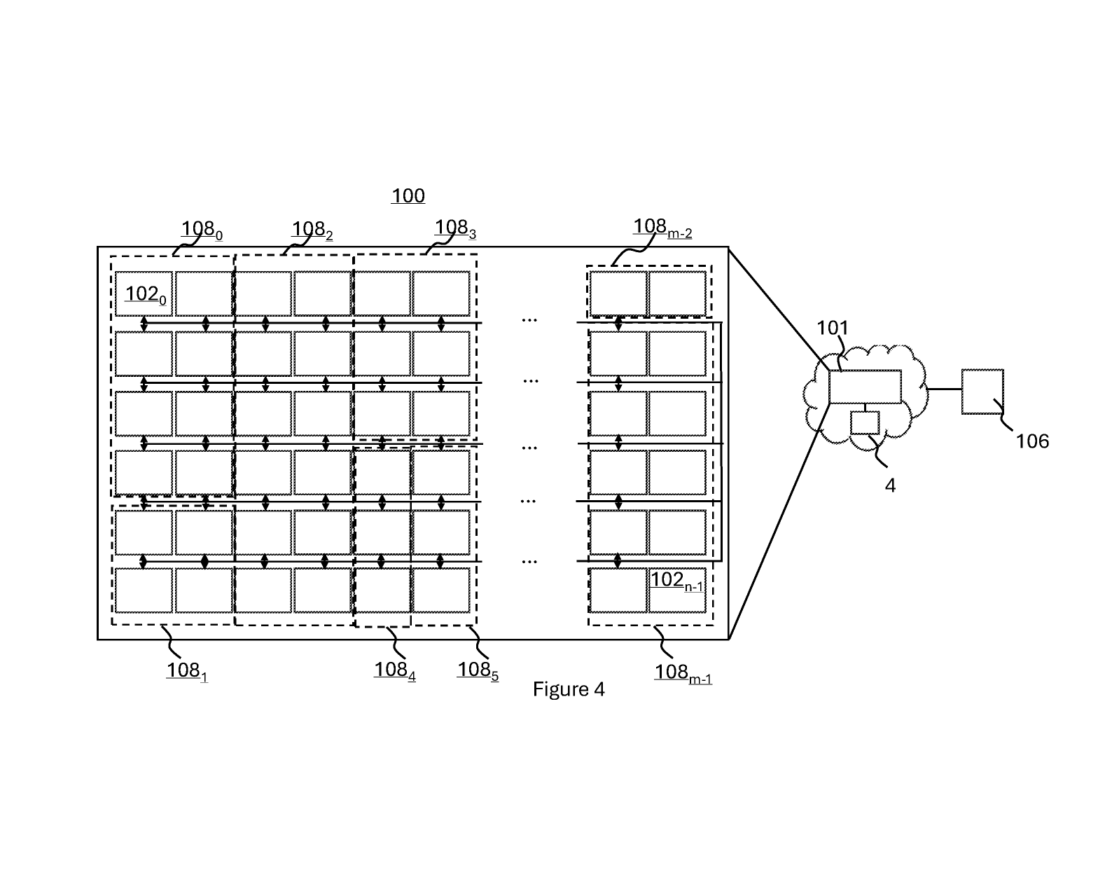

As an illustrative example, FIG. 4 schematically shows a block diagram of system 100, where a plurality of compute units 102ₙ are arranged in a compute array 101, depicted as a system on chip (SoC), such as a server SoC. In the present illustrative example, each compute unit 102ₙ comprises a CPU, although the claims are not limited in this respect and the compute units may comprise a NE, GPU etc.

Each CPU may comprise one or more cores, where each core may be used to process job request(s) (e.g. threads).

A number of cores may be bound together in a group 108ₘ e.g. as a virtual machine (VM), where the size of a group may be assessed based on the characteristics or requirements of the job request (e.g. size, priority etc.).

As described in the examples in FIGS. 2 to 4 above, at least one control unit 4 is provided to receive requests for faster transitions to a high performance state.

For example, each group 108ₘ may send, to the control unit 4, a request for permission for the compute units to perform processing in accordance with a first transition setting.

The control unit 4 determines, responsive to each request, whether the number of compute units permitted to transition to the high performance state in accordance with the first transition setting is above a threshold. When the number of compute units permitted to transition to the high performance state in accordance with the first transition setting does not exceed the threshold of requests, then, the control unit provides permission to each particular compute unit in the group 108ₘ to transition to the high performance state in accordance with the first transition setting (i.e. a relatively fast transition from a low performance state to a high performance state).

On the other hand, when the number of compute units permitted to transition to the high performance state in accordance with the first transition setting does exceed the threshold of requests, any additional groups requesting permission are not provided with permission (i.e. permission is withheld or denied) and the cores of any additional groups above the threshold number will transition to the high performance state in accordance with the second transition setting (i.e. a relatively slow transition from a low performance state to a high performance state).

When permission is received, the cores execute the load step in accordance with the first transition setting (i.e. where the cores transition to a high performance state relatively quickly compared to when transitioning to the high performance state in accordance with the second transition setting). When the processing transition is complete, the groups may relinquish permission (e.g. delete permission from storage) or the permission may expire responsive to a validity duration of the permission elapsing. When no permission is received (i.e. where permission is withheld or denied), the cores of the group will transition to the high performance state in accordance with the second transition setting (i.e. where the cores transition to a high performance state relatively slowly compared to when transitioning to the high performance state in accordance with the first transition setting).

In some embodiments, when permission is granted for some but not all cores of a particular group, then all the cores of that group may transition to the high performance state in accordance with the default second transition setting, as cores in the particular group operating with reduced performance compared to others in that group may negatively impact the operation of the group as a whole as the cores operating with increased performance may have to wait/stall for data from the cores operating with reduced performance.

In embodiments, the first transition setting for the core may be a configuration setting where the core is permitted to transition to a high performance state at a faster transition rate compared to cores transitioning to the high performance state in accordance with the second transition setting. For example, when transitioning to the high performance state in accordance with the second transition setting, cores in the group may transition to the high performance state slower than when transitioning to the high performance state in accordance with the first transition setting, where “no-operations” or “bubbles” may be inserted into the command stream to reduce performance of the cores.

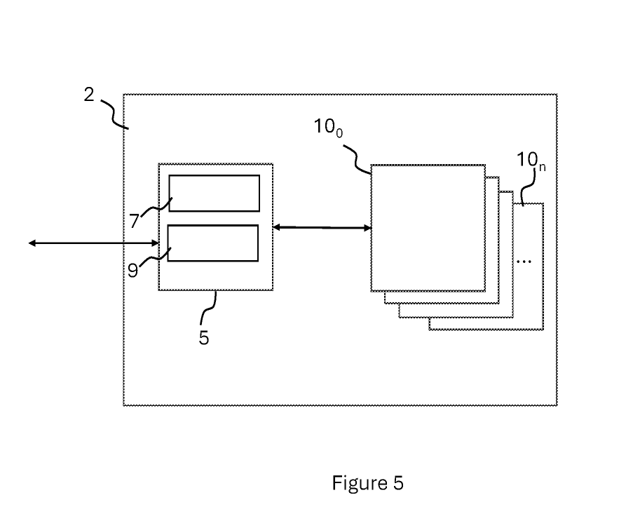

FIG. 5 schematically shows an example of a compute unit 102 in accordance with the present techniques;

As above the compute unit 102 may comprise a CPU, NPU or GPU although the claims are limited in this regard.

The compute unit 2 may comprise one or more functional units 10 to process data depending on the data to be processed.

As an illustrative example, for an NPU, a first functional unit 10 of the one or more functional units may comprise a convolution engine to perform convolution operation while a second functional unit may be a non-convolution engine to perform operations other than convolution operations, such as a vector engine to perform elementwise operations. As a further illustrative example, for an CPU, a functional unit of the one or more functional units may comprise an execution engine to process data. As a further illustrative example, for a GPU, a functional unit of the one or more functional units may comprise a graphics execution unit to execute shader programs.

The compute unit 2 includes a command component or command stream front end component 5 (hereafter “command component” 5). The command component 5 may comprise various hardware or software components to interface with one or more hardware or software components external to the compute unit 2 (not shown, but reflective of such components interfaced via the bidirectional arrow from command component 5 to external to the compute unit 2).

As an example, the command component 5 may comprise a request unit 7 to communicate with an external control unit to request/receive permission therefrom. As a further example, the command component 5 may comprise storage 9 to store the received permission.

As will be appreciated, FIG. 5 is exemplary only and a compute unit may have additional or alternative components that are not depicted in FIG. 5.

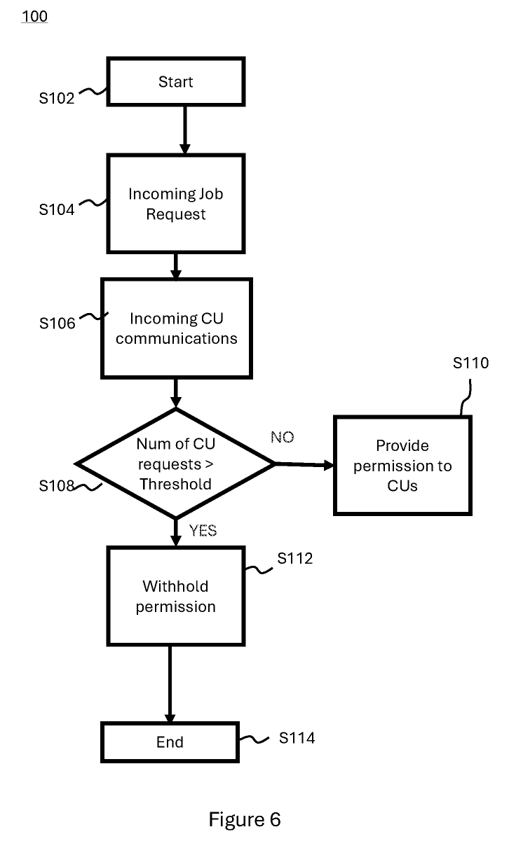

FIG. 6 schematically shows a simplified flow diagram of a method of operation 100 of the control unit according to one implementation of the present techniques.

At S102 the method starts.

At S104 a job request is provided to a plurality of compute units.

At S106 a control unit receives requests from the plurality of compute units to perform processing the job in accordance with a first transition setting.

At S108 the control unit determines, responsive to each request, whether the number of compute units permitted to transition to the high performance state in accordance with the first transition setting is above a threshold.

When the number of compute units permitted to transition to the high performance state in accordance with the first transition setting does not exceed the threshold of requests, then, at S110, the control unit provides permission to each particular compute unit to transition to the high performance state in accordance with the first transition setting. Permission may be provided to a particular compute unit by way, for example, of a token or by setting a value of a register at the particular compute unit or by setting a flag at the particular compute unit. The claims are not limited in this respect, and permission may be granted in any suitable manner.

In embodiments, the permission (e.g. token, value, flag etc.) may have an associated validity duration which may be set by the control unit.

At S112, when the number of compute units permitted to transition to the high performance state in accordance with the first transition setting does exceed the threshold of requests, any additional compute units are not provided with permission (i.e. permission is withheld or denied) and the additional compute units above the threshold number will only transition in accordance with the second transition setting.

Compute units permitted to transition to the high performance state in accordance with the first transition setting may, at S106, inform the control circuitry when the transition is complete and the control unit may provide permission to a further compute unit permitted to transition to the high performance state in accordance with the second transition setting to transition to the high performance state in accordance with the first transition setting, thereby enabling the compute unit to transition to the relatively high performance state more quickly than would otherwise be permitted.

At S114 the method 100 ends.

Thus the control unit functions as an arbiter to control the compute units in the data processing system to ensure that the number of compute units permitted to transition to the high performance state in accordance with the first transition setting is within the capabilities of the PDN.

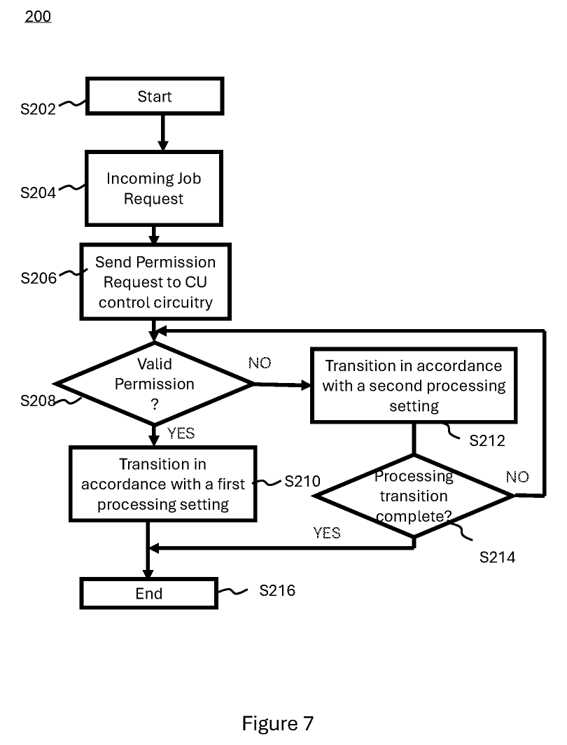

FIG. 7 schematically shows a simplified flow diagram of a method of operation 200 of a compute unit in accordance with the present techniques.

At S202 the method starts.

At S204 the compute unit receives a job request from an application.

At S206 the compute unit sends, to a control unit, a request for permission to perform processing in accordance with a first transition setting.

At S208, it is determined whether or not the compute unit has permission for a relatively fast transition to the high performance state.

At S210, when permission is obtained, the compute unit processes the job in accordance with the first transition setting.

At S212, when permission is not received (i.e. where permission is withheld or denied, or where permission is expired), the compute unit will transition to the high performance state in accordance with the second transition setting. In an illustrative example, for an NE, groups of DPUs in of the DPU array are enabled to operate in a staggered manner or, for a CPU, bubbles or “no operations” may be added to the command stream to reduce the transition rate to the high performance state.

When, at S214, permission is received before processing of the job completes, then the compute unit can transition to the high performance state in accordance with the first transition setting, where, when the compute unit is an NE, any remaining DPUs to be enabled may be enabled to operate substantially simultaneously rather than in a staggered manner or for a core, no bubbles are added to the command stream.

At S216 the method of operation 200 ends.

Thus, the present techniques provide a hardware control unit that can, with low latency, manage permissions for compute units to transition to the high performance state in accordance with a first transition setting when permitted, or to transition to the high performance state in accordance with a second transition setting when no permission is received or when a valid permission subsequently becomes invalid. The hardware control unit is provided to keep track of all the rates of ramping to higher load currents when multiple compute units concurrently indicate an imminent increase in power level to control the transition settings of the compute units accordingly. Providing a control unit to control the transition settings of the compute units in this manner provides a mechanism for maintaining power integrity of the system as the number of compute units transitioning concurrently in accordance with the first transition setting can be controlled to ensure that the load step does not exceed a threshold thereby, for example, reducing the likelihood of a voltage droop.

The first transition setting has a transition duration that is shorter than the inverse of the frequency of dominant resonances in the impedance spectrum of the Power Distribution Network. Such functionality provides a direct benefit to power distribution network (PDN) design of a system as such a scheme need only account for a threshold number of compute units permitted to transition to the high performance state in accordance with the first transition setting instead of having to over-design the system to take account of all compute units concurrently (substantially simultaneously) transitioning to the high performance state in accordance with the first transition setting. Therefore, the control unit provides an agile system that can service transition requests very quickly.

The embodiments above typically describe a control unit configured to provide permission to a compute unit to transition to a high performance state in accordance with a first transition setting defining a particular transition rate responsive to a determination that the first compute unit would not exceed a threshold number of compute units permitted to transition in accordance with the first transition setting. It will be appreciated that the relatively fast transition rates of the different control units may be different from one another. Put another way, the relatively fast transition rates need not be identical across all compute units, rather the relatively fast transition rate for a particular compute unit will be faster than the default transition rate for that particular compute unit (i.e. the transition rate which that particular compute unit will use to transition from a low performance state to a high performance state when permission is not granted). The specific transition rates for a particular compute unit may be set, for example, by the resource management processor.

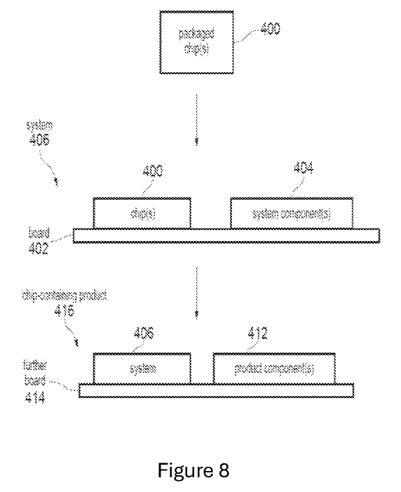

As shown in FIG. 8, one or more packaged chips 400, with the circuitry described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e., a modular chiplet with particular functionality or a chiplet may be performing a number of different functions) may itself be referred to as a chip. A chiplet is packaged together with other chiplets into a multi-chiplet semiconductor package (e.g., using a packaged substrate or an interposer, or by using three-dimensional integration to provide a multi-layer chip product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g., plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface component, a resistor, a capacitor, an inductor, a transformer, a diode, a voltage regulator, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface component; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g., a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

As will be appreciated by one skilled in the art, the present technology may be embodied as a method, a circuit or a computer readable medium comprising data and imperatives to cause construction of a circuit. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to…” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A control unit for controlling processing transitions at a plurality of compute units, the control unit comprising:
a request analysis component to receive, from a first compute unit, a request to transition from a first performance state to a second performance state in accordance with a first transition setting and to determine the number of compute units permitted to transition from the first performance state to the second performance state in accordance with the first transition setting, where the first transition setting is to define a transition rate for the transition;
a control unit configured to provide, to the first compute unit, permission for the first compute unit to transition in accordance with the first transition setting responsive to a determination that the first compute unit would not exceed a threshold number of compute units permitted to transition in accordance with the first transition setting.

2. The control unit of claim 1, where the control unit is configured to, responsive to a determination that the first compute unit would exceed the threshold number, withhold permission from the first compute unit to cause the first compute unit to transition in accordance with a second transition setting.

3. The control unit of claim 1, where the control unit comprises a counter to track the number of compute units permitted to transition in accordance with the first setting.

4. The control unit of claim 3, where the counter is incremented when a compute unit is provided with permission.

5. The control unit of claim 4, where the permission comprises a validity duration.

6. The control unit of claim 5, comprising a timer initiated responsive to providing the permission and where the counter is decremented responsive to the timer reaching a specified value.

7. The control unit of claim 1, where the control unit comprises a hardware unit.

8. A system to perform processing comprising:
the control unit of claim 1; and
a compute unit comprising:
an interface component to communicate with the control unit;
a functional unit capable of transitioning from a first performance state to a second performance state in accordance with a first transition setting or a second transition setting, where the first transition setting is to define a first transition rate for the transition and where the second transition setting is to define a second transition rate for the transition;
where the interface component is configured to request, from the control unit, permission to transition in accordance with the first transition setting.

9. The system of claim 8, wherein when permission is received the functional unit is to transition from the first performance state to the second performance state in accordance with the first transition setting.

10. The system of claim 8, wherein when permission is not received the functional unit is to transition from the first performance state to the second performance state in accordance with the second transition setting.

11. The system of claim 8, where the first transition rate is faster than the second transition rate.

12. The system of claim 10, where a load step of the first transition rate is steeper than the load step of the second transition rate.

13. The system of claim 8, where the request for permission is generated responsive to one or more signals from a further processor to indicate that a desired transition rate for a required transition to a high performance state may exceed a permitted transition rate.

14. The system of claim 8, where the compute unit further comprises storage to store the received permission.

15. The system of claim 14, where the received permission comprises one or more of a token, a stored value, a flag status.

16. A method of controlling processing transitions at a plurality of compute units, the method comprising:
receiving, at a control unit from a compute unit, a request for the compute unit to transition from a first performance state to a second performance state in accordance with a first transition setting, where the first transition setting is to define a first transition rate for the transition;
determining, at the control unit, the number of compute units permitted to transition from the first performance state to the second performance state in accordance with the first transition setting;
providing, to the compute unit, permission to transition in accordance with the first transition setting responsive to a determination that providing the permission would not exceed a threshold number of compute units permitted to transition in accordance with the first transition setting.

17. The method of claim 16, further comprising;
transitioning, at the compute unit, from the first performance state to the second performance state in accordance with the first transition setting responsive to receiving permission.

18. The method of claim 16, further comprising;
transitioning, at the compute unit, from the first performance state to the second performance state in accordance with a second transition setting responsive to permission being denied or invalid, where the second transition setting is to define a second transition rate.

19. The method of claim 18, where the first transition rate is faster than the second transition rate.

20. The method of claim 16, where determining the number of compute units permitted to transition from the first performance state to the second performance state in accordance with the first transition setting comprises:
determining the number of compute units permitted to transition from the first performance state to the second performance state in accordance with the first transition setting within a time window.
